(19) United States
(12) Patent Application Publication
(10) Pub. No.: US 2005/0094014 A1
(43) Pub. Date: May 5, 2005

(54) Slider bar interface for digital camera

(76) Inventors: William R. Haas, Fort Collins, CO (US); Kirk S. Tecu, Greeley, CO (US); James S. Voss, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/699,979

(22) Filed: Nov. 3, 2003

(51) Int. Cl. H04N 5/222; H04N 5/225

(52) U.S. Cl. 348/333.01; 348/373

(57) ABSTRACT

A digital camera having an improved user interface for use in viewing and editing still images and viewing and editing video, along with a method of displaying, editing and scrolling through video recorded by the digital camera. The user interface includes a display device for selectively displaying recorded images, a slide bar, and left and right slidable buttons that are moveable in left and right directions across the slide bar and that are operative to display and scroll through recorded still frames of the video corresponding to the location of the respective slidable button. The left and right slidable buttons are depressible to activate respective switches, wherein the left slidable button is depressible to select the first frame of video and crop preceding frames, and wherein the right slidable button is depressible to select the last frame of video and crop succeeding frames.

### TECHNICAL FIELD

The present invention relates generally to digital cameras, and more specifically, to a digital camera, slide bar interface and method of displaying, editing and scrolling through video recorded by a digital camera.

### BACKGROUND

The assignee of the present invention develops digital cameras, and the like. Such digital cameras may be used to store or record still images and video images.

It is desirable to have the ability to display and edit the recorded video and to scroll through frames of the recorded video. Prior implementations that address this are relatively slow and are relatively unintuitive.

It would be desirable to have an intuitive digital camera interface that provides for fast and efficient display and editing of recorded video and scrolling through frames of the recorded video. One aspect of the present invention provides a slider bar interface for use with digital cameras, and improved methods of displaying, editing and scrolling through video recorded by the digital camera.

### SUMMARY OF THE INVENTION

One embodiment of the present invention provides a digital camera having an improved user interface for use in viewing still images, viewing video, and editing video. A method of displaying, editing and scrolling through video recorded by a digital camera is also provided.

An exemplary user interface comprises a liquid crystal display (LCD) for displaying color images and text overlay, two slider buttons and one slide bar under the display. Each slider button is capable of moving left or right (but not past each other) and each slider button can also be depressed, activating a switch.

By way of example, the way this interface works to crop a video recorded by the camera is as follows. The video is selected for viewing on the LCD through a menu and file selection system similar to what exists today.

Instead of the video playing, it is displayed in still frames only. The frame being displayed corresponds to the position of whichever slider button is being moved and defaults to the left slider button position. For example, if the left slider button is in the middle when the video is selected for viewing then the frame that is in the middle of the video is displayed. If the user moves the left slider button to the left, then the video frame changes (going backwards) to correspond to the position of the slider button. If the right slider button is moved then the camera automatically displays the video frame corresponding to the position of the right slider button.

Using the above-described method, the user can select the first and last frame of the video. To crop the video the user depresses the slider buttons. When the left slider button is pressed, the video is cropped so it starts at the frame corresponding to the position of the left slider button. The same thing happens using the right slider button.

Implementations of the present invention provide for a simpler and more intuitive user interface than what has been done before allowing the user to quickly and easily scroll through many images in a digital camera and edit the images, whether still images or video.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIGS. 1a and 1b are front and back views, respectively, that illustrate an exemplary embodiment of a digital camera employing an user interface in accordance with the principles of the present invention; and

FIG. 2 is a flow diagram illustrating an exemplary method in accordance with the principles of the present invention.

### DETAILED DESCRIPTION

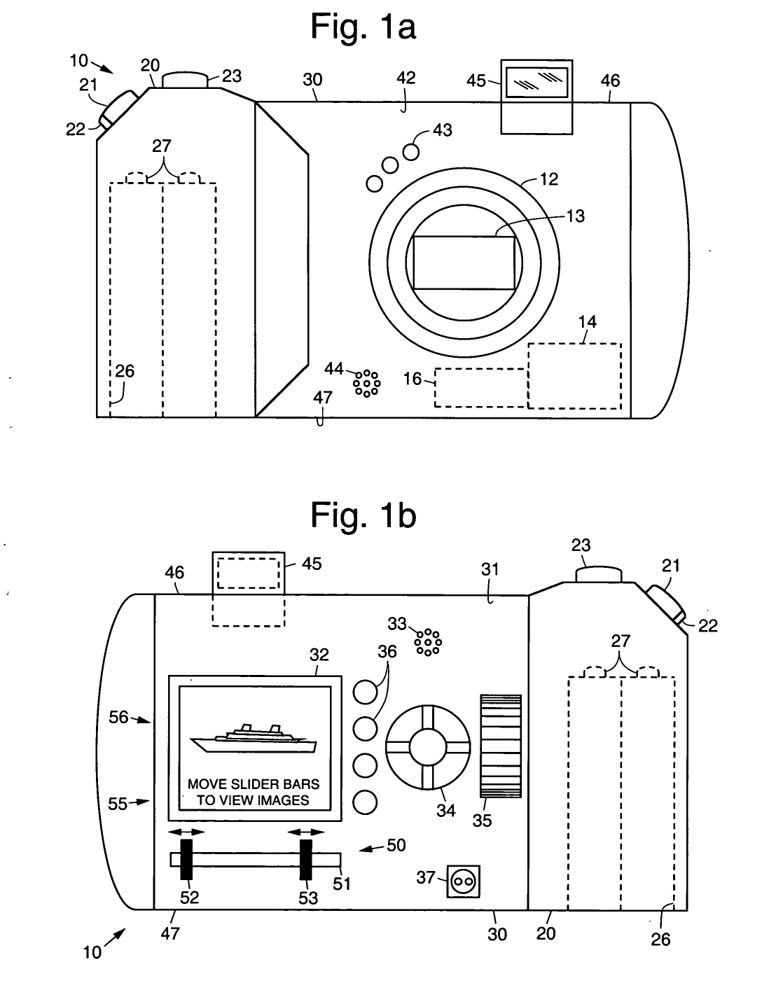

Referring to the drawing figures, FIGS. 1a and 1b show front and back views, respectively, that illustrate an exemplary embodiment of a digital camera 10 in accordance with the principles of the present invention. The exemplary digital camera 10 comprises an improved user interface 50.

The exemplary digital camera 10 comprises a handgrip section 20 and a body section 30. The handgrip section 20 includes a power button 21 having a lock latch 22, a shutter button or record button 23, and a battery compartment 26 for housing batteries 27. As is shown in FIG. 1a, a metering element 43 and microphone 44 are disposed on a front surface 42 of the digital camera 10. A pop-up flash 45 is located adjacent the top surface 46 of the digital camera 10.

As is shown in FIG. 1a, the digital camera 10 also comprises a lens or imaging optics 12, and an image sensor 13 for receiving optical images transmitted by the imaging optics 12 and capturing digital images thereof. A processor 14 (or microprocessors 14) is coupled to the image sensor 13 (and other control and input/output components). A memory device 16 is coupled to the image sensor 13 and processor 14 that is used to store captured images.

As is shown in FIG. 1b, a rear surface 31 of the exemplary digital camera 10 includes a display device 32, such as a color liquid crystal display (LCD), for example, a rear microphone 33, a joystick pad 34, a zoom control dial 35, a plurality of buttons 36 for setting functions of the camera 10 and an output port 37 for downloading images to an external display device or computer, for example.

The digital camera 10 comprises an improved user interface 50 in accordance with the present invention for use in viewing still images, viewing video, and editing video. An exemplary user interface 50 comprises the liquid crystal display (LCD) 32 capable of displaying color images 56 and text overlay 55, two slider buttons 52, 53 and one slide bar 51 which may preferably be located beneath the liquid crystal display 32, although the location may vary. Each slider button 52, 53 is capable of moving left or right (indicated by the arrows above the slider buttons 52, 53) but not past each other, and each slider button 52, 53 is depressible, activating a switch. Thus, the slider buttons 52, 53 comprise movable switching devices.

By way of example, the way the interface 50 works to crop video recorded by the camera 10 is as follows. The video is selected for viewing on the liquid crystal display 32 using a menu and file selection system used in existing cameras, for example. The menu and file selection system may be implemented in the exemplary digital camera 10 using the joystick pad 34 and/or selected ones of the plurality of buttons 36, for example.

Instead of the video playing, still frames of the video are displayed, such as the image 56 shown in FIG. 1b. The frame that is displayed corresponds to the position of whichever slider button 52, 53 is being moved and defaults to the position of the left slider button 52. For example, if the left slider button 52 is in the middle of the slide bar 51 when the video is selected for viewing, then the frame that is in the middle of the video is displayed. If the user moves the left slider button 52 to the left, then the video frame changes (going backwards) to correspond to the position of the left slider button 52. If the right slider button 53 is moved, then the camera 10 automatically displays the video frame corresponding to the position of the right slider button 53.

Using the above-described method, the user can select the first and last frame of the video. To crop the video the user depresses the slider buttons 52, 53. When the left slider button 52 is pressed, the video is cropped so it starts at the frame corresponding to the position of the left slider button 52. The same thing happens using the right slider button 53.

The slider buttons 52, 53 can also be used to view still images stored in the camera 10. For example, if the camera 10 has ten images stored and the left slider button 52 is 30% to the right then the third image will be displayed. As the slider button 52 is moved the displayed image will change. This allows a user to quickly scroll through stored images. This feature will become more important as camera image storage capacity increases and camera microprocessors 14 become capable of processing data quickly enough to efficiently perform this function.

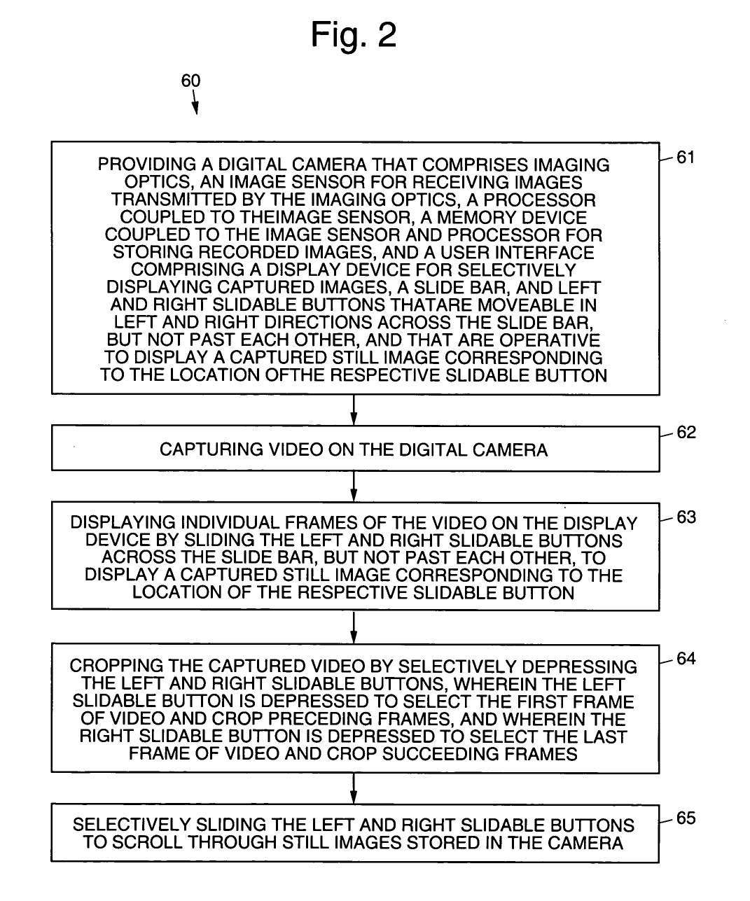

FIG. 2 is a flow diagram illustrating an exemplary method 60 of the present invention. The exemplary method 60 comprises the following steps.

A digital camera 10 is provided 61 that comprises imaging optics 12, an image sensor 13 for receiving optical images transmitted by the imaging optics 12 and capturing digital images thereof, a processor 14 coupled to the image sensor 13, a memory device 16 coupled to the image sensor 13 and processor 14 for storing captured images, and a user interface 50 comprising a display device 32, such as a liquid crystal display, for example, for selectively displaying recorded images, a slide bar 51, and left and right slidable buttons 52, 53 that are moveable in left and right directions across the slide bar 51, but not past each other, and that are operative to display a recorded still image corresponding to the location of the respective slidable button 52, 53.

Video is recorded 62 by the digital camera 10. Individual frames of the video are displayed 63 on the display device 32 by sliding the left and right slidable buttons 52, 53 across the slide bar 51, but not past each other, to display a recorded still image corresponding to the location of the respective slidable button. The recorded video is cropped by selectively depressing 64 the left and right slidable buttons 52, 53, wherein the left slidable button 52 is depressed to select the first frame of video and crop preceding frames, and wherein the right slidable button 53 is depressed to select the last frame of video and crop succeeding frames. A user may scroll 65 through images stored in the camera 10 by selectively sliding 65 the left and right slidable buttons 52, 53.

Thus, an improved digital camera, slide bar interface and method have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

1. A digital camera comprising:
an image sensor for capturing digital images;
a processor coupled to the image sensor;
a memory device coupled to the image sensor and processor for storing captured images; and
a user interface comprising a display device for selectively displaying stored images, a slide bar, and left and right slidable buttons that are moveable in left and right directions across the slide bar and that are operative to display a stored still image corresponding to the location of the respective slidable button.

2. The digital camera recited in claim 1 wherein the left and right slidable buttons are depressible to activate respective switches.

3. The digital camera recited in claim 2 wherein the left slidable button is depressible to select the first frame of video and crop preceding frames, and wherein the right slidable button is depressible to select the last frame of video and crop succeeding frames.

4. The digital camera recited in claim 1 wherein the display device is capable of displaying color images and text overlay.

5. The digital camera recited in claim 4 wherein the display device comprises a liquid crystal display.

6. The digital camera recited in claim 1 wherein the left and right slidable buttons are slidable to scroll through images stored in the camera.

7. A method comprising the steps of:
providing a digital camera that comprises an image sensor for capturing digital images, a processor coupled to the image sensor, a memory device coupled to the image sensor and processor for storing captured images, and a user interface comprising a display device for selectively displaying recorded images, a slide bar, and left and right slidable buttons that are moveable in left and right directions across the slide bar, but not past each other, and that are operative to display a recorded still image corresponding to the location of the respective slidable button;
recording video on the digital camera; and
displaying Individual frames of the video on the display device by sliding the left and right slidable buttons across the slide bar to display a stored still image corresponding to the location of the respective slidable button.

8. The method recited in claim 7 wherein the recorded video is cropped by selectively depressing the left and right slidable buttons, wherein the left slidable button is depressed to select the first frame of video and crop preceding frames, and wherein the right slidable button is depressed to select the last frame of video and crop succeeding frames.

9. The method recited in claim 7 wherein the display device is capable of displaying color images and text overlay.

10. The method recited in claim 7 wherein the display device comprises a liquid crystal display.

11. The method recited in claim 7 further comprising the step of selectively sliding the left and right slidable buttons to scroll through images stored in the camera.
